(19) United States
(12) Patent Application Publication
(10) Pub. No.: US 2012/0166709 A1
(43) Pub. Date: Jun. 28, 2012

(54) FILE SYSTEM OF FLASH MEMORY

(76) Inventor: Han Sung CHUN, Daejeon (KR)

(21) Appl. No.: 13/289,414

(22) Filed: Nov. 4, 2011

(30) Foreign Application Priority Data
Dec. 23, 2010 (KR) 10-2010-0134063

(51) Int. Cl. G06F 12/00

(52) U.S. Cl. 711/103; 711/E12.008

(57) ABSTRACT

A file system of a flash memory includes: a file system layer; a physical erase block (PEB) layer configured to recognize a PEB of the flash memory by the unit of PEB address; and a logical erase block (LEB) layer positioned under the file system layer and over the PEB layer and configured to provide an LEB address mapped to the PEB to the file system layer.

### CROSS-REFERENCES TO RELATED APPLICATIONS

The present application claims priority under 35 U.S.C. 119(a) to Korean Application No. 10-2010-0134063, filed on Dec. 23, 2010, in the Korean intellectual property Office, which is incorporated herein by reference in its entirety set forth in full.

### BACKGROUND

Exemplary embodiments of the present invention relate to a file system of a flash memory, and more particularly, to a file system of a flash memory which simplifies a metadata information storage system, thereby reducing a mount time and a main memory usage amount during operation.

Recently, the use of various mobile devices has increased, and the use of embedded systems having a large capacity flash memory mounted therein has also increased.

A great part of them has adopted a file system mounted on a pure flash memory to store data.

The file system includes real data stored in a storage space and metadata indicating the storage position of the real data.

An existing disk file system stores metadata in the front of a storage space and stores real data in the rest of the storage space. Such a system may read only the metadata region during mount, has a simple data structure, and, does not use a large amount of main memory.

However, the disk file system cannot be directly used in a flash memory.

A flash memory has a wear-out characteristic, that is, has a limit to the number of operations of erasing blocks and rewriting blocks. In order to overcome such a limit, the flash memory should perform wear-leveling such that the respective blocks are uniformly worn out.

However, since the disk file system does not have a wear-leveling function, the disk file system cannot be directly used in a flash memory.

Considering such a situation, a flash file system has been constructed for a flash memory. The flash file system uses a log-structured file system or a tree-based data structure.

The log-structured flash file system may include a journaling flash file system (JFFS2) operating on a memory technology device (MTD) layer, a yet another flash file system (YAFFS2) and so on, and the tree-based data structure may include an unsorted block image file system (UBIFS) operating on an UBI layer.

The log-structured file system considers a storage space as one log, and sequentially writes data in a storage space from the front of the storage space.

At this time, metadata is stored together with the data, and a mapping table based on the metadata is configured and managed on a main memory.

In this case, during mount of the file system, the entire flash memory region should be read to search for the metadata, and a mapping table should be configured on the memory. Therefore, the mount time takes a long time, and a large amount of main memory is consumed to maintain the mapping table.

Furthermore, the mount time increases in proportion to the capacity of the flash memory.

When the tree-based data structure is used, a large amount of main memory is also consumed for the data structure, while the mount time is short.

The above-described technical configuration is a related art for helping an understanding of the present invention, and does not indicate a prior art which is widely known in the technical field to which the present invention pertains.

### SUMMARY

An embodiment of the present invention relates to a file system of a flash memory which simplifies a metadata information storage system, thereby reducing a mount time and a main memory usage amount during operation.

In one embodiment, a file system of a flash memory includes: a file system layer; a physical erase block (PEB) layer configured to recognize a PEB of the flash memory by the unit of PEB address; and a logical erase block (LEB) layer positioned under the file system layer and over the PEB layer and configured to provide an LEB address mapped to the PEB to the file system layer.

The LEB layer may convert the PEB into the LEB, and store an erase counter in the PEB to perform wear-leveling.

The wear-leveling may be performed by the unit of PEB.

The LEB layer may store metadata in a specific LEB according to log-structured file system.

The metadata may include the size of the file system, an inode list range, a data page range, an idle inode list, an idle data page list, and a dirty page list.

The LEB layer may attach a sequence number to the metadata, when storing the metadata.

The LEB layer may store data in LEBs other than the specific LEB for storing the metadata, according to log-structured file system.

The PEB may include a header recorded therein, and the header stores an LEB address and an erase counter.

The erase counter may be stored in a first page of the PEB.

### BRIEF DESCRIPTION OF THE DRAWINGS

The above and other aspects, features and other advantages will be more clearly understood from the following detailed description taken in conjunction with the accompanying drawings, in which:

FIG. 1 is a diagram explaining the configuration of a file system of a flash memory in accordance with an embodiment of the present invention;

FIG. 2 is a diagram explaining a mapping operation between a logical erase block (LEB) layer and a physical erase block (PEB) layer in accordance with the embodiment of the present invention;

FIG. 3 is a diagram explaining the configuration of metadata in accordance with the embodiment of the present invention; and

FIG. 4 is a diagram explaining an inode list in accordance with the embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

The drawings are not necessarily to scale and in some instances, proportions may have been exaggerated in order to clearly illustrate features of the embodiments. Furthermore, terms to be described below have been defined by considering functions in embodiments of the present invention, and may be defined differently depending on a user or operator's intention or practice. Therefore, the definitions of such terms will be based on the descriptions of the entire present specification.

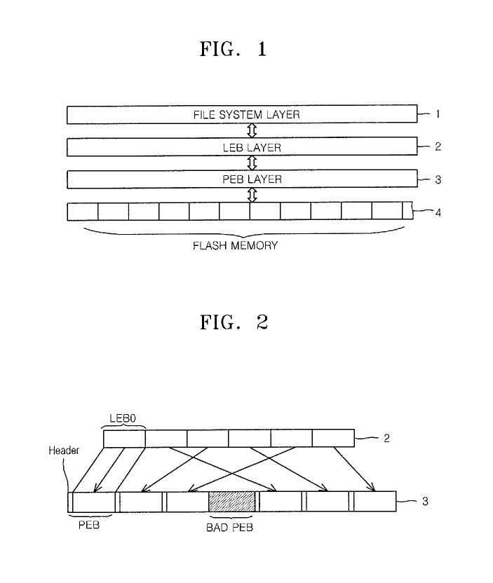

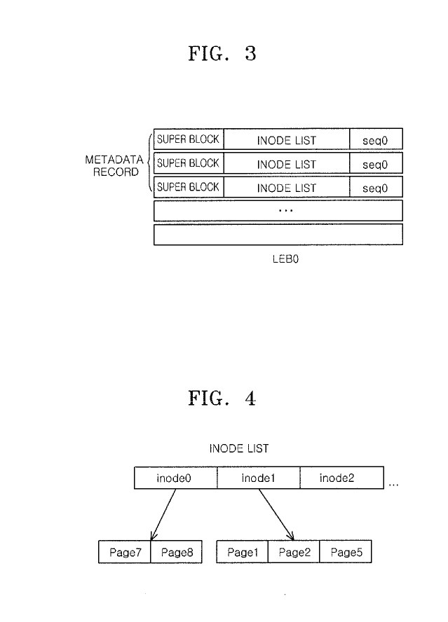

FIG. 1 is a diagram explaining the configuration of a file system of a flash memory in accordance with an embodiment of the present invention. FIG. 2 is a diagram explaining a mapping operation between a logical erase block (LEB) layer and a physical erase block (PEB) layer in accordance with the embodiment of the present invention. FIG. 3 is a diagram explaining the configuration of metadata in accordance with the embodiment of the present invention. FIG. 4 is a diagram explaining an inode list in accordance with the embodiment of the present invention.

Referring to FIG. 1, a flash memory 4 includes a plurality of PEBs each having a plurality of pages. In the case of a large block NAND flash memory, one page is 2 KB, and 64 pages form one PEB.

A write operation is performed by the unit of page, and is referred to as program.

In order to re-program a page which has been programmed one time, a PEB to which the page belongs is first erased. However, the erase number has a limit. Therefore, when the erase number reaches a limit, the corresponding erase block cannot be used (bad block).

Accordingly, because of the inability of flash memory to perform in-place update, wear-leveling is required to use a block which is less worn out.

Referring to FIGS. 1 and 2, the file system of the flash memory in accordance with the embodiment of the present invention includes a file system layer 1, an LEB layer 2, and a PEB layer 3.

The PEB layer 3 recognizes a PEB of the flash memory by the unit of PEB address.

The LEB layer 2 is positioned under the file system layer 1 and over the PEB layer 3 and provides an LEB address mapped to a PEB of the flash memory 4 to the file system layer 1.

The LEB layer 2 converts the PEB to an LEB and stores an erase counter in the PEB to perform wear-leveling by the unit of PEB.

Referring to FIGS. 1 to 3, the LEB layer 2 stores metadata in a specific LEB according to log-structured file system. When storing the metadata, the LEB layer 2 attaches a sequence number to the metadata.

The unit of address in data mapping information for each file within the metadata is defined as N×page, and is equalized to the page size of a normal flash memory (that is, N=1). Furthermore, data is stored according to a log-structured file system.

The file system of the flash memory configured in such a manner will be described in more detail as follows.

Referring to FIGS. 1 and 2, the LEB layer 2 is provided over the PEB layer 3 which associates an LEB having an LEB address with a PEB of the flash memory, and recognizes a PEB by the unit of PEB address.

Any PEB may be mapped to an LEB address, and wear-leveling is performed by the unit of PEB.

A header is recorded in each PEB. The header stores an LEB address and erase counter information, and the header is stored in a first page of each PEB.

The file system layer 1 accesses the LEB layer 2 at an LEB address, and the LEB layer 2 converts the LEB address into a PEB address and delivers the contents of the corresponding PEB.

When in-place update occurs in an LEB, a PEB which is less worn out is selected by referring to the erase counter and then connected to the LEB. Since the LEB layer 2 performs wear-leveling by the unit of PEB, it is possible to prevent a specific PEB from being worn out even though a write operation is continuously performed in the specific LEB.

The upper file system layer 1 operates on an address space provided by the lower LEB layer 2.

The metadata system basically has a similar structure to a general form of a file system (for example, ext2, ext3 or the like) which is used when a Unix-like operating system such as Linux uses a hard disk as a storage device.

Referring to FIG. 3, metadata includes a super block and an inode list.

The super block has information such as the size of the file system, an inode list range, a data page range, an idle inode list, and an idle data page list. In addition, the super block may contain information required for increasing the efficiency of mapping information operation, for example, a dirty page list.

As file data are changed, metadata for mapping the file data is also changed. A unit for storing the changed metadata is referred to as a record.

One record stores a super block and an inode list together or separately.

Regardless of whether the super block and the inode list are stored together or separately, each metadata record has a sequence number. The sequence number sequentially increases whenever a new record is written.

The metadata record is stored in a page within specific LEBs. For example, whenever a metadata record is newly written in LEB0, the metadata record is sequentially stored in a next page within the designated LEB.

That is, the write operation is performed according to a log-structured file system. Subsequently, when the file system is mounted, only specific LEB(s) for metadata may be read to check which record is an effective record, through a sequence number.

Referring to FIG. 4, each inode on an inode list corresponds to one file, and stores page address information indicating which pages contain data composing the corresponding file.

That is, each inode contains mapping information. For example, when a file has 3 KB data, the data are stored in two 2 KB pages, and the inode contains an address for the two pages.

When only one page (PEB header) for each erase block and the LEBs are read through such a metadata configuration, it is possible to obtain mapping information on data of each file without reading the entire flash memory.

Therefore, the mount time is reduced. Although the flash memory capacity increases, an increase of the mount time is very small.

Furthermore, since the mapping information is configured in a simple table form like existing disk file systems, a small amount of main memory is used.

Data are written in the other LEBs excluding the LEB for metadata. When file data are changed during a data write operation, the LEB layer performs wear-leveling by the unit of erase block. Therefore, in-place update may be performed.

However, since an erase operation is performed even though data may be written in another page without an erase operation, the entire lifetime of the flash memory is reduced. Therefore, every write operation is performed according to log-structured file system.

That is, data are sequentially stored in the other LEBs from the first LEB, excluding the LEB for metadata.

In this case, since both of the changed data and the previous data remain in the flash memory, a large space is consumed in comparison with an effective usage amount.

When writable pages are completely consumed, in-place update should be performed. Therefore, an erase operation occurs.

As described above, the LEB layer performs wear-leveling at an erase block level. However, when a dirty page was previously arranged, it is possible to further reduce the erase number. Therefore, the dirty page may be periodically arranged during the file system operation.

As such, the file system in accordance with the embodiment of the present invention may simplify the metadata information storage system, thereby reducing the mount time and the main memory usage amount during operation. Therefore, the booting time of a device may be reduced, and an available main memory space may be increased.

In accordance with the embodiment of the present invention, it is possible to reduce a mount time required for reading metadata for driving the file system and a memory usage amount. Therefore, the booting time of a device may be reduced, and an available main memory space may be further secured.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A file system of a flash memory, comprising:
a file system layer;
a physical erase block (PEB) layer configured to recognize a physical erase block (PEB) of the flash memory by the unit of PEB address; and
a logical erase block (LEB) layer positioned under the file system layer and over the PEB layer and configured to provide an LEB address mapped to the PEB to the file system layer.

2. The file system of claim 1, wherein the LEB layer converts the PEB into the LEB, and stores an erase counter in the PEB to perform wear-leveling.

3. The file system of claim 2, wherein the wear-leveling is performed by the unit of PEB.

4. The file system of claim 1, wherein the LEB layer stores metadata in specific LEBs according to log-structured file system.

5. The file system of claim 4, wherein the metadata comprises the size of the file system, an inode list range, a data page range, an idle inode list, an idle data page list, and a dirty page list.

6. The file system of claim 4, wherein the LEB layer attaches a sequence number to the metadata, when storing the metadata.

7. The file system of claim 4, wherein the LEB layer stores data in LEBs other than the specific LEB for storing the metadata, according to a log-structured file system.

8. The file system of claim 1, wherein the PEB comprises a header recorded therein, and the header stores an LEB address and an erase counter.

9. The file system of claim 1, wherein the header is stored in a first page of the PEB.
